(19) United States
(12) Patent Application Publication
(10) Pub. No.: US 2024/0091714 A1
(43) Pub. Date: Mar. 21, 2024

(54) Strong Hollow-Fiber Membranes for Saline Desalination and Water Treatment

(71) Applicants: Gradiant Corporation, Woburn, MA (US); National University of Singapore, Singapore (SG)

(72) Inventors: Looh Tchuin Choong, Singapore (SG); Liang Canzeng, Singapore (SG); Chung Shung, Singapore (SG); Mohammad Askari, Singapore (SG)

(73) Assignees: Gradiant Corporation, Woburn, MA (US); National University of Singapore, Singapore (SG)

(21) Appl. No.: 18/262,818

(22) PCT Filed: Feb. 2, 2022
(86) PCT No.: PCT/IB2022/050909

§ 371 Date: Jul. 25, 2023

(30) Foreign Application Priority Data
Feb. 2, 2021 (SG) 10202101091U

(51) Int. Cl. B01D 69/02; B01D 69/08; B01D 69/12; B01D 71/56

(52) U.S. Cl. CPC B01D 69/02; B01D 69/081; B01D 69/1251; B01D 71/56; B01D 2325/025; B01D 2325/026; B01D 2325/04; B01D 2325/20; B01D 2325/24; C02F 1/441

(57) ABSTRACT

A thin-film-composite hollow-fiber membrane includes a phase-inversion layer, which is in the form of a hollow fiber, and an active layer coated on the phase-inversion layer. The active layer selectively allows passage of water molecules but rejects at least some dissolved ions. The thin-film-composite hollow-fiber membrane can have an internal burst pressure of at least 4 MPa. In a method for forming the membrane, the polymer concentration in the spinning dope from which the hollow-fiber substrate is formed can have a polymer concentration no greater than 5% below the critical concentration.

### TECHNICAL FIELD

The invention is generally directed to hollow-fiber membranes for desalinating saline solutions and treatment of aqueous solutions.

### BACKGROUND ART

The discussion of the background state of the art, below, may reflect hindsight gained from the disclosed invention(s); and these characterizations are not necessarily admitted to be prior art.

Population explosion and rapid industrialization have imposed a great demand on clean water production. Currently, the dominant process to produce drinkable water is based on reverse osmosis (RO). However, the conventional RO process only has a maximum recovery rate of about 35-50% because it is confined by the maximum salinity (e.g., >70 g/L) of the feed and practical issues, such as the mechanical strength of membranes and economic and environmental concerns. As the water recovery increases, the saline feed becomes more concentrated. Thus, the RO process must consume extra energy to overcome the osmotic pressure of the concentrated saline water. What's more, the treatment of the concentrated RO effluent stream is not cheap. For instance, 5% to 33% of the total cost of the RO desalination process is owed to the disposal of the RO effluent. Moreover, most feed water is not recovered and wasted. To meet the zero liquid discharge (ZLD) objective, one must further increase the recovery rate to a membrane system to facilitate crystallization in a downstream process and achieve nearly 100% water recovery and production of mineral salts.

To harvest more water and increase the concentration of RO brine before entering a downstream process such as a crystallizer, membrane distillation (MD) and osmotically assisted reverse osmosis (OARO) have been proposed. The former is based on a thermal-driven process where water vapor is transferred from a hot saline feed to a cold salt-free permeate stream due to the vapor pressure difference across the membrane, while the latter is a pressure-driven process by combining both the forward osmosis (FO) and RO principles. Today, both still face challenges to be overcome. The design of MD membranes with anti-wetting and anti-fouling properties is troublesome because the feed water consists of many unwanted foulants and salts. In contrast, the OARO process is operated at extremely high pressures, most commercially available membranes cannot withstand such high pressures. In addition, increasing membrane thickness to improve its mechanical strength alone cannot solve the problem because it would also result in severe internal concentration polarization (ICP) and lower the driving force for water transport. Hence, a desired OARO membrane must have high rejection and mechanical properties but minimal ICP.

Basically, OARO is similar to RO where water transports across a semi-permeable membrane by using a hydraulic pressure to overcome the osmotic pressure difference between the feed and permeate. Unlike RO, OARO has a saline sweep in the permeate side to decrease the osmotic pressure difference across the membrane. This process modification assists water transport even when the feed has an osmotic pressure higher than the burst or crush pressure of the membrane. Therefore, OARO can operate at lower operating pressures and is more energy saving than one or multi-stage RO. In typical OARO operations, a feed with a high hydraulic pressure and a high salinity is circulated in one side of the module, while a sweep with a low pressure and a low or equal salinity flows counter-currently in the other side. The hydraulic transmembrane pressure between the feed and the sweep is greater than the osmotic pressure difference across the membrane. As a result, the water transports from the feed to the sweep. Currently, a water recovery of around 70% is possible for seawater via OARO. To further increase water recovery and energy saving, robust OARO membranes with good salt rejection, higher mechanical strength and minimal ICP must be developed.

Several TFC-PES hollow fiber membranes and module have been demonstrated to harvest osmotic energy from pressure retarded osmosis (PRO). However, they cannot withstand a hydraulic pressure more than 4 MPa, and they cannot effectively be employed for seawater RO and OARO.

### SUMMARY

A thin-film-composite hollow-fiber membrane and methods for synthesizing the membranes are described herein, where various embodiments of the apparatus and methods may include some or all of the elements, features and steps described below.

A thin-film-composite hollow-fiber membrane includes a phase-inversion layer, which is in the form of a hollow fiber, and an active layer coated on the phase-inversion layer. The active layer selectively allows passage of water molecules but rejects at least some dissolved ions. The thin-film-composite hollow-fiber membrane has an internal burst pressure of at least 4 MPa.

A method for synthesizing the thin-film-composite hollow-fiber membrane includes forming a spinning dope comprising a polymer, a polar solvent, a pore-forming additive, a nonsolvent, and a mineral additive. Using a spinneret that has an external orifice and an internal orifice, the spinning dope is extruded through the external orifice through an air gap into a coagulation bath containing a coagulant and simultaneously flowing a bore fluid through the internal orifice to form a hollow-fiber substrate. The hollow-fiber substrate is then post-treated by immersing it in a glycerol solution; and an active layer is formed on a surface of the hollow-fiber substrate. In this method, the resulting thin-film-composite hollow-fiber membrane with a burst pressure of at least 4 MPa.

In another method for synthesizing a thin-film-composite hollow-fiber membrane, the above steps are performed with the polymer concentration in the spinning dope being no greater than 5% below the critical concentration.

Advantages that can be provided by the methods and structures, described herein, can include high mechanical strength membranes with high rejection ratios and minimal ICP for both RO and OARO applications. The hollow-fiber configuration is chosen in this study because it has several advantages over the flat-sheet one, such as a larger surface to volume ratio, a smaller system footprint, and self-supporting characteristics. The newly developed thin-film composite (TFC) membranes can include a polyamide selective layer synthesized via interfacial polymerization on the inner surface of polyethersulfone (PES) hollow-fiber substrates that have been optimized by controlling the bore and dope fluid flow rates, fiber dimension and morphology. The polyamide layer is employed as the selective layer because it is known to have a high rejection and a reasonably good permeability for seawater desalination. PES is chosen as the substrate material because of its good mechanical properties, chemical resistance and hydrolysis resistance. The inner-selective configuration is selected to design the composite hollow-fiber membranes because this configuration can be scaled up easily for commercialization.

### BRIEF DESCRIPTION OF DRAWINGS

FIG. 1 provides plots of shear viscosity vs. polymer concentration for a polyethersulfone (PES) dope solution at 25° C. with a curve 12 of best fit.

FIG. 2 is a schematic illustration of a setup for reverse osmosis (RO), pressure retarded osmosis (PRO), and osmotically assisted reverse osmosis (OARO) testing.

FIG. 3 includes plots showing the effect of wall thickness 38 on the burst pressure 40 of hollow-fiber substrates.

FIG. 4 includes plots showing the effect of wall thickness 38 on the Young's modulus 42 of hollow-fiber substrates.

FIG. 5 includes images taken using field emission scanning electron microscopy (FESEM), illustrating the morphologies of overall cross-sections of the as-spun PES hollow-fiber substrates.

FIG. 6 includes images taken using FESEM, illustrating the morphologies of enlarged cross-sections of the as-spun PES hollow-fiber substrates.

FIG. 7 shows morphologies and structures of the representative PES hollow-fiber substrates, spun at condition E with a dope-to-bore (D/B) flow ratio of 10.

FIG. 8 plots RO performance, in terms of water permeability 43 and salt rejection 45, at different spinning conditions for thin-film-composite—polyethersulfone (TFC-PES) hollow-fiber membranes, tested at 2 MPa with a feed solution of 2000 ppm NaCl.

FIG. 9 includes images taken using FESEM, illustrating the morphologies of the inner surface and edge of TFC-PES hollow-fiber membranes spun at different D/B ratios.

FIG. 10 shows concentration polarization (CP) in a pressure-driven RO mode with the flow of water through the membrane 44 shown with the arrow 48, wherein the external concentration of the feed 46 in the bulk of the liquid (C_{F,b}) is lower than the external concentration of the feed 46 at the membrane (C_{F,m}).

FIG. 11 shows concentration polarization (CP) in a pressure-driven OARO mode, wherein C_{F,b} is greater than or equal to the internal concentration in the bulk of the sweep liquid (C_{S,b}), wherein C_{F,b}<C_{F,m}, and wherein internal concentration of the sweep liquid 50 at the interface with the active layer 44 of the membrane (C_{S,i}) is less than the internal concentration in the bulk of the sweep liquid 50 (C_{S,b}).

FIG. 12 shows concentration polarization (CP) in an osmotic-driven forward osmosis (FO) mode, wherein C_{F,b}<C_{F,m}, and wherein the internal concentration of the draw solution 52 at the interface with the active layer 44 of the membrane (C_{D,i}) is less than the internal concentration in the bulk of the draw solution 52 (C_{D,b}).

FIG. 13 shows concentration polarization (CP) in an osmotic-driven PRO mode, wherein C_{F,b} is less than the internal concentration of the feed 46 at the interface with the active layer 44 of the membrane (C_{F,i}). and wherein the external concentrate of the draw solution 52 at the outer surface of the active layer 44 of the membrane (C_{D,m}) is less than external concentration in the bulk of the draw solution 52 (C_{D,b}).

FIG. 14 plots the structural parameter 54, wall thickness 38, and porosity 56 of TFC-PES hollow fiber membranes spun at different D/B ratios.

FIG. 15 plots the OARO water flux (LMH) of the optimal TFC-PES hollow fiber membranes as a function of operating pressure (MPa) with sodium chloride concentrations (C_{NaCl}) of 0.6 mol/L and 1.2 mol/L for three conditions (i.e., condition D 58, condition E 60, and condition F 62).

FIG. 16 plots the OARO water permeability (LMH/MPa) of the optimal TFC-PES hollow fiber membranes as a function of operating pressure (MPa) with sodium chloride concentrations (C_{NaCl}) of 0.6 mol/L and 1.2 mol/L for three conditions (i.e., condition D 58, condition E 60, and condition F 62).

FIG. 17 plots the OARO water permeability (LMH/MPa) of the optimal TFC-PES hollow fiber membranes as a function of feed NaCl concentration (mol\L) with sodium chloride concentrations (C_{NaCl}) of 0.6 mol/L and 1.2 mol/L for three conditions (i.e., condition D 58, condition E 60, and condition F 62).

FIG. 18 includes six cross-sectional images (A-F) of hollow fiber membranes taken using field-emission scanning electron microscopy (FESEM), illustrating membranes with an inner layer full of finger-like macrovoids and an outer layer with a sponge-like microstructure with the thicknesses of each layer indicated for various conditions. Condition A (top left) is characterized by a dope-to-bore-flow-rate ratio (D/B ratio) of 3.0, wherein the percentage of the thickness of the fiber radius in the form of the finger-like structure is 66%. Condition B (top center) is characterized by a dope-to-bore-flow-rate ratio (D/B ratio) of 5.0, wherein the percentage of the thickness of the fiber radius in the form of the finger-like structure is 63%. Condition C (top right) is characterized by a dope-to-bore-flow-rate ratio (D/B ratio) of 7.5, wherein the percentage of the thickness of the fiber radius in the form of the finger-like structure is 59%. Conditions D and E (bottom left and bottom center) are characterized by a dope-to-bore-flow-rate ratio (D/B ratio) of 10.0, wherein the percentage of the thickness of the fiber radius in the form of the finger-like structure is 56%. Condition F (bottom right) is characterized by a dope-to-bore-flow-rate ratio (D/B ratio) of 13.3, wherein the percentage of the thickness of the fiber radius in the form of the finger-like structure is 57%.

In the accompanying drawings, like reference characters refer to the same or similar parts throughout the different views. The drawings are not necessarily to scale; instead, an emphasis is placed upon illustrating particular principles in the exemplifications discussed below. For any drawings that include text (words, reference characters, and/or numbers), alternative versions of the drawings without the text are to be understood as being part of this disclosure; and formal replacement drawings without such text may be substituted therefor.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. The term, “about,” can mean within ±10% of the value recited. In addition, where a range of values is provided, each subrange and each individual value between the upper and lower ends of the range is contemplated and therefore disclosed.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video or audio form) for assembly and/or modification by a customer to produce a finished product.

Osmotically assisted reverse osmosis (OARO) is an emerging membrane technology for dewatering from saline streams. A strong membrane that can withstand a high hydraulic pressure is crucial for the OARO process. We have developed ultra-strong polymeric thin-film-composite (TFC) hollow-fiber membranes with hydraulic burst pressures of about 7 to 11 MPa under the in-to-out mode (allowing for higher operating pressure for higher permeate production), while possessing a pure water permeability (PWP) and a NaCl rejection of around 30 L/(m² h MPa) (LMH/MPa) and 98%, respectively (a membrane with a high PWP and a high salt rejection can reduce the footprint of the system and achieve a high concentration factor). The ultra-strong TFC hollow-fiber membranes are achieved mainly by (1) tuning the concentration of the host polymer (polyethersulfone, PES) in spinning dopes and (2) engineering the fiber dimension and morphology. The optimal TFC membrane has been evaluated under the OARO operation mode where the feed and sweep streams have the same NaCl concentration.

Experimental results show that its water flux decreases from around 57 to 1.7 LMH (i.e., the corresponding water permeability declines from 19 to 0.6 LMH/MPa) when the NaCl concentration varies from 0.3 to 1.2 mol/L at 3 MPa (which renders the membranes suitable for dewatering from saline under the OARO process). The decreases in water flux and permeability are mainly arisen from the dilutive effect of the inner concentration polarization (ICP) that reduces the effective driving force across the membrane. To the best of our knowledge, the newly developed PES-TFC membranes are the strongest inner-selective hollow-fiber membranes ever reported in literatures in terms of burst pressure. The as-invented ultra-strong TFC hollow-fiber membranes are applicable for desalination and water treatments.

Osmotically assisted reverse osmosis (OARO) has been recently proposed to increase the water recovery of the reverse osmosis (RO) process, in which RO has reached its limitations. Strong membranes are essential for both OARO and RO processes. Here, we have developed high mechanical strength thin-film composite (TFC) hollow-fiber membranes for both RO and OARO processes. The newly developed TFC hollow-fiber membranes consist of a polyamide layer synthesized via interfacial polymerization on the inner surface of polyethersulfone (PES) hollow-fiber substrates that have been optimized by controlling the bore and dope fluid flow rates, fiber dimension and morphology. The thin-film-composite—polyethersulfone (TFC-PES) hollow-fiber membranes have a pure water permeability (PWP) of around 25 to 30 L/(m² h MPa) (LMH/MPa) and a NaCl rejection of around 97.5 to 98% for brackish water desalination at 2 MPa. The water permeability drops from 21.5 to 0.6 LMH/MPa when the NaCl concentration increases from 0.035 mol/L (2000 ppm) to 1.2 mol/L at 3 MPa for OARO due to the concentrative and dilutive concentration polarization [i.e., external concentration polarization (ECP) and inner concentration polarization (ICP)] that decreases the effective driving force. The structural parameter (S) and burst pressure (P_{B}) of the newly developed membranes increase from 550 to 800 μm and from 4.7 to 10.4 MPa, respectively, with an increase in the dope-to-bore-flow rate ratio (D/B ratio) because of the thicker substrate wall and reduction in porosity. The optimal TFC-PES hollow-fiber membrane for OARO has a burst pressure of 9.5 MPa, structural parameter of 795 μm and water permeability of 0.9 LMH/MPa when using 1.2 mol/L NaCl for OARO. To the best of our knowledge, this inner-selective TFC-PES hollow-fiber membrane has the highest burst pressure to date, it has impressive high mechanical strength and good RO and OARO performance.

### EXAMPLES

Materials:

Polyethersulfone (PES, from Solvay Advanced Polymer), polyethylene glycol 400 [PEG400, molecular weight (MW)=400 g/mol, from Millipore Sigma], N-methyl-2-pyrrolidone (NMP, >99.5%, EMPLURA solvent from Millipore Sigma), deionized (DI) water, and calcium chloride (CaCl₂, from Merck), were used to prepare the polymer dopes for the fabrication of hollow-fiber substrates. A glycerol (industrial grade, from Aik Moh Paints & Chemicals) aqueous solution (50/50 wt %) was utilized for the post-treatment of as-spun PES hollow-fiber substrates. M-phenylenediamine (MPD, >99%, from Tokyo Chemical Industry), sodium dodecyl sulphate (SDS, >97%, from Honeywell Fluka), trimesoyl chloride (TMC, >98%, from Tokyo Chemical Industry), and hexane (>99.9%, from Fisher Chemicals) were used for interfacial polymerization. Sodium chloride (NaCl, 99.5%, from Merck) was employed for the membrane characterizations and reverse-osmosis performance tests.

Dope Preparation and Characterizations:

The dope solutions were prepared by dissolving polyethersulfone (MW=150,000) pellets in solutions of NMP, PEG400, H₂O and CaCl₂. Briefly, a mixture of NMP and PEG 400 was stirred for 30 minutes. Then, the PES polymer, which had been vacuum dried at 80° C. for 24 h, was added into the NMP/PEG400 solution at 60° C. until complete dissolution. Once the polymer dope was cooled down to room temperature, a pre-determined amount of the deionized (DI) water/CaCl₂ solution was added into it dropwise. The polymer dope was continuously stirred until becoming homogeneous. It was then degassed overnight and loaded into a syringe pump (from TELEDYNE ISCO) for spinning.

To choose a proper polyethersulfone concentration in spinning dopes, the critical concentration of polyethersulfone solutions was measured. The critical concentration is the concentration of a polymer in a spinning dope at which extensive chain entanglement occurs. To determine the critical concentration, the viscosity of a polymer solution is measured for a range of polymer concentrations—for example, by using a rotational cone-and-plate rheometer. At both low-polymer concentrations and high-polymer concentrations, the slope of the concentration-viscosity relationship is approximated as linear; and the intersection of these slopes on a concentration-viscosity chart corresponds to the critical concentration.

Solutions with different polyethersulfone concentrations were prepared, and their shear viscosity was determined using a rotational cone-and-plate rheometer (model AG-G2, from TA Instruments, USA) with a diameter of 40 mm and 1° cone geometry at a shear rate of 100 s⁻¹. [FIG. 1] shows the relationship between shear viscosity and polyethersulfone concentration via a best-fit curve 12 for the plotted data points for the solution. Because hollow fibers spun from the critical concentration of 30.5 wt. % tended to form membrane surfaces with minimal pores, a polyethersulfone composition of 26 wt. % was chosen as the spinning dope in this study because the resultant hollow fibers might be porous with low transport resistance but with good mechanical properties.

Fabrication of Polyethersulfone Hollow-Fiber Substrates:

The polyethersulfone hollow-fiber substrates were fabricated by a dry-jet wet-spinning process through a single-layer spinneret. Table 1 summarizes the detailed spinning parameters and conditions. The volumetric flowrates of the bore fluid and the dope fluid were varied so that the dope-to-bore-fluid flowrate ratio (i.e., D/B ratio) was in the range of 3-13.3. The as-spun polyethersulfone hollow-fiber substrates were immersed in tap water for two days to remove the residual solvents and additives and then post-treated in a glycerol aqueous solution (50/50 wt. %) for another two days to prevent pore collapse before the subsequent air-drying process.

TABLE 1

| Membrane ID Code | A | B | C | D | E | F |
|---|---|---|---|---|---|---|
| Dope Flow Rate (ml/min) | 3 | 3 | 3 | 3 | 4 | 4 |
| Bore Fluid Flow | 1 | 0.6 | 0.4 | 0.3 | 0.4 | 0.3 |
| Rate (ml/min) | | | | | | |
| Dope/Bore Fluid Flow | 3.0 | 5.0 | 7.5 | 10.0 | 10.0 | 13.3 |
| Rate Ratio | | | | | | |
| Take Up Speed (m/min) | 3.95 | 3.55 | 3.52 | 3.44 | 3.50 | 3.40 |
| (Free Fall) | | | | | | |

| | |
|---|---|
| Bore Fluid | DI Water |
| Dope solution components | PES/NMP/PEG400/CaCl₂/H₂O |
| Dope Composition (wt. %) | 26/36/36/1/1 |
| Air Gap (cm) | 5 |
| External Coagulant | Tap Water |

Fabrication of Thin-Film-Composite—Polyethersulfone Hollow-Fiber Membranes:

Three polyethersulfone hollow-fiber substrates with an effective length of about 15 cm were assembled in parallel to make lab-scale modules. Each module was soaked in deionized (DI) water for at least 60 minutes before interfacial polymerization. First, a 2 wt. % M-phenylenediamine (MPD) aqueous solution containing 0.1 wt. % sodium dodecyl sulphate (SDS) was circulated on the lumen side of the substrates for 3 minutes and the excessive MPD solution was removed by purging air for 5 minutes. Second, a 0.15 wt. % trimesoyl chloride (TMC) solution in hexane was circulated into contact with MPD that had been absorbed on the inner surfaces of the substrates for 5 minutes to form a thin polyamide selective layer. The resultant thin-film-composite—polyethersulfone (TFC-PES) hollow-fiber membranes were purged with air for 1 minute to remove the residual hexane. After that, the TFC-PES hollow-fiber membranes were ready for characterizations and reverse-osmosis (RO) and osmotically-assisted-reverse-osmosis (OARO) evaluations.

Characterizations of Reverse Osmosis Substrates and Thin-Film-Composite—Polyethersulfone Hollow-Fiber Membranes:

To observe the morphology of polyethersulfone hollow-fiber substrates and thin-film-composite—polyethersulfone hollow-fiber membranes, the samples were fractured in liquid nitrogen and coated with platinum using a platinum (Pt) sputter coater (JEOL JFC-1300 coater from JEOL Ltd.) at 20 mA for 90 s. The fiber morphology was observed using field-emission scanning electron microscopy (FESEM, JEOL, JSM6700LV microscope from JEOL Ltd.).

To measure the bulk porosity of polyethersulfone hollow-fiber substrates, the pristine substrates (i.e., without the glycerol aqueous treatment) were cut into segments of 50 mm and dried in a freeze dryer overnight to minimize the effects of the residual solvents and additives on porosity. The membrane porosity (ε_{M}, %) was calculated from the mass of the hollow-fiber segments (m) and the mass of a solid polyethersulfone cylinder, as shown in Eq. (1), below, where ρₚ is the polyethersulfone density of 1.37 g/cm³; L, OD, ID are the length, outer and inner diameters of the hollow-fiber substrate, respectively.

$$\begin{matrix}[ Math . 1 ] & \\ {ε}_{M} = ( 1 - \frac{m}{\frac{1}{4} π L {ρ}_{p} ( {OD}^{2} - {ID}^{2} )} ) & ( 1 )\end{matrix}$$

Mechanical properties of hollow-fiber substrates including the maximum tensile strain (i.e., the elongation at break), maximum tensile stress, and Young's modulus were measured by an Instron tensiometer (Model 3342, Instron) under a constant elongation rate of 10 mm/min with an initial sample length of 50 mm, while their outer and inner diameters were determined by a stereo microscope (OLMPUS, Model: SZX2-ILLT). Five samples were tested to minimize the experimental error and ensure the accuracy.

The burst pressures of hollow-fiber substrates and thin-film-composite—polyethersulfone hollow-fiber membranes are used as a measure of membrane toughness under pressure. Membranes with a high burst pressure are more suitable for high pressure operations in RO and OARO processes. The burst pressure was determined using a hand pump (KYOWA, Japan; Model: T300NDX, range: 0-30 MPa). Briefly, the membrane module was connected to the hose of the hand pump, water was then pumped slowly into the lumen of the hollow fibers to eliminate the trapped air. Then the pressure within the lumen was increased by pushing the handle downward with hands. The burst pressure was recorded when there was a sudden drop in the pressure gauge because of structural failure in at least one of these hollow fibers.

Determination of Thin-Film-Composite—Polyethersulfone Hollow-Fiber Membrane Performance for RO:

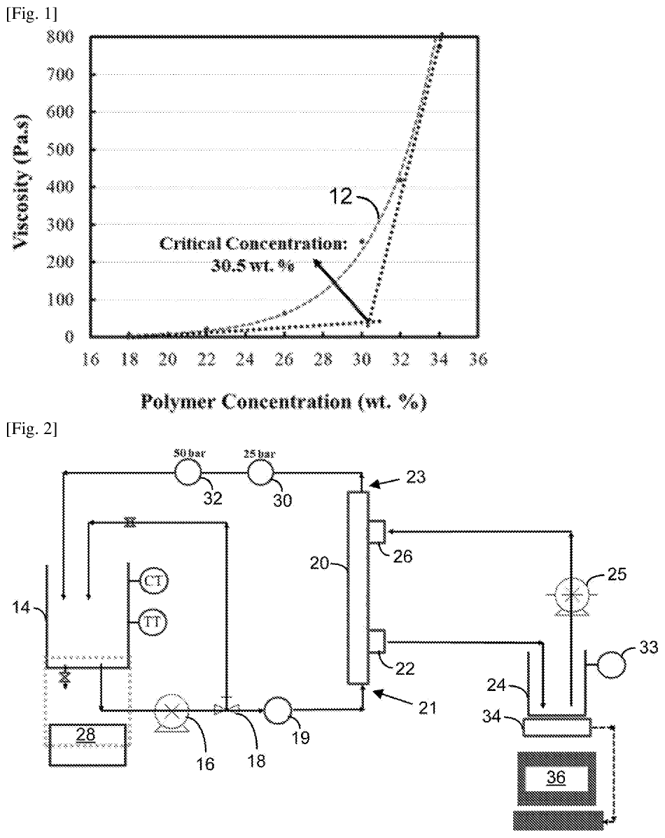

The pure-water permeability (PWP) (L/(m² h MPa), or LMH/MPa), salt rejection (Rⱼ), salt permeability (B), and water permeability (J_{w}) of the TFC-PES hollow-fiber membrane were measured using a reverse osmosis (RO) setup, as shown in [FIG. 2]. The system shown therein, includes a feed tank 14 containing feed liquid that is maintained at 25° C. by a thermostat bath 28; the feed tank is also configured with a conductivity transmitter 15 and a temperature transmitter 17 for measuring and transmitting the conductivity and temperature, respectively, of the feed liquid in the feed tank 14. Feed liquid is pumped from the feed tank 14 via a hydraulic pump 16 through a conduit through a three-way valve 18 and through a flowmeter 19 to measure the flow rate (from 0-3,000 ml/min) and into a membrane module 20 through a lumen-side feed inlet 21. The membrane module 20 contains the thin-film-composite hollow-fiber membrane, described infra. Permeate that has passed through the membranes in the membrane module 20 is output from the shell-side feed outlet 22 of the membrane module 20 through a conduit to a permeate (water) tank 24. Water from the permeate tank 24 is fed by a peristaltic pump 25 via a conduit to a shell-side feed inlet 26 of the membrane module 20. A lumen-side feed-outlet stream from the membrane module 20 is recycled through a lumen-side feed outlet 23 and via a conduit, including a pressure-relief valve 30 and a pressure transmitter 32, back to the feed tank 14. The permeate tank 24 is configured with a conductivity transmitter 33 for measuring and transmitting the conductivity of the permeate in the permeate tank 24 and is positioned on an electronic balance 34 in electronic communication with a computer 36 for tracking the weight of the permeate from the membrane module 20. The tests were performed in a counter-current mode using a feed solution of 25° C. kept by a thermostat bath.

The setup shown in [FIG. 2] allows four different types of osmotic operation for the purpose of testing various membrane parameters and characterizing the membrane's performance under these types of operation. In this test system, the outlet stream from the permeate tank 24 is recycled back to the feed tank 14 to facilitate operation of the tests. In a commercial system, this recycling step would be optional. The test setup also comprises a bypass stream split from the lumen-side feed-inlet stream by the three-way valve 18. The purpose of the bypass stream from the three-way valve 18 is to facilitate lumen-side feed-inlet flow rates below the minimum flow rate of the hydraulic pump 16. In a commercial system, this bypass stream would also be optional. The different types of osmotic operation are described, below.

For standard reverse osmosis (RO), a lumen-side feed-inlet stream is introduced to the membrane module 20. Pressure is applied on the lumen side, such that the difference in hydraulic pressure between the solution on the lumen side and the solution on the shell side of the fibers overcomes the difference in osmotic pressure between the sides, causing a portion of the water from the lumen-side feed inlet 21 to permeate through the membrane into the shell side of the membrane module 20 to form a shell-side feed-outlet stream having a lower osmotic pressure than the lumen-side feed-inlet stream. The passage of permeate through the membrane leaves behind a lumen-side feed-outlet stream having a higher osmotic pressure than the lumen-side feed-inlet stream. No shell-side feed-inlet is supplied in this type of operation. The RO process typically results in a desalinated product stream and a concentrated feed stream. However, the salinity of suitable feed streams and the factor to which they can be concentrated is limited by the amount of hydraulic pressure that the membrane can withstand.

For osmotically assisted reverse osmosis (OARO), a lumen-side feed-inlet stream and a shell-side feed-inlet stream are introduced to the membrane module 20. The osmotic pressure of the lumen-side feed-inlet stream is greater than or equal to the osmotic pressure of the shell-side feed-inlet stream. As in RO, pressure is applied on the lumen side, such that the difference in hydraulic pressure between the solution on the lumen side and the solution on the shell side overcomes the difference in osmotic pressure between the sides, causing a portion of the water from the lumen-side feed-inlet 21 to permeate through the membrane into the shell side of the membrane module 20. The permeate combines with the shell-side feed-inlet stream to form a shell-side feed-outlet stream having a lower osmotic pressure than the shell-side feed-inlet stream. The passage of permeate through the membrane leaves behind a lumen-side feed-outlet stream having a higher osmotic pressure than the lumen-side feed-inlet stream. The OARO process typically results in a saline product stream having a reduced osmotic pressure and a concentrated feed stream. OARO processes are usually operated in conjunction with RO processes in order to produce a desalinated product stream from the reduced-osmotic-pressure stream, or operated in conjunction with additional OARO stages to produce a further-concentrated feed stream.

For forward osmosis (FO), a feed-inlet stream and a sweep-inlet stream are introduced into the membrane module 20. The osmotic pressure of the sweep-inlet stream is greater than the osmotic pressure of the feed-inlet stream. Typically, the hydraulic pressures of the two streams are about equal; but if there is a pressure difference between the sweep-inlet stream and the feed-inlet stream, it must be less than the difference in osmotic pressure. As a result of these osmotic and hydraulic pressure conditions, a portion of the water from the feed side diffuses through the membrane into the sweep side to form a sweep-outlet stream having a lower osmotic pressure than the sweep-inlet stream. The remainder of the feed-inlet stream that does not diffuse through the membrane exits the membrane module 20 through the lumen-side feed outlet 23 as a feed-outlet stream, having a higher osmotic pressure than the feed-inlet stream. Typically, the feed-inlet stream is introduced to the lumen side of the membrane module 20, and the sweep-inlet stream is introduced to the shell side of the membrane module 20. However, the reverse may also be practiced, where the feed-inlet stream is introduced to the shell side and the sweep-inlet stream is introduced to the lumen side. The FO process nearly always results in a product stream having a higher osmotic pressure than the original feed stream. However, the FO process can be useful in cases where the feed stream contains difficult-to-treat contaminants, such as scalants, or when the product stream can be made to contain solutes having desirable properties.

Finally, for pressure-retarded osmosis (PRO), a lumen-side feed-inlet stream and a shell-side feed-inlet stream are introduced to the membrane module 20. The osmotic pressure of the lumen-side feed-inlet stream is greater than or equal to the osmotic pressure of the shell-side feed-inlet stream. The hydraulic pressure of the lumen-side feed is greater than or equal to the hydraulic pressure of the shell-side feed-inlet stream. The difference between the osmotic pressure of the lumen-side feed-inlet stream and the shell-side feed-inlet stream overcomes the hydraulic pressure differential, causing a portion of the water from the shell-side feed-inlet stream to permeate through the membrane into the lumen side of the membrane module 20 and combine with the lumen-side feed-inlet stream to create a lumen-side feed-outlet stream having a lower osmotic pressure than the lumen-side feed-inlet stream. The remaining portion of the shell-side feed-inlet stream that is retained by the membrane exits the membrane module as the shell side feed outlet stream, and has a higher osmotic pressure than the shell-side feed-inlet stream. The PRO process results in a pressurized product stream from which mechanical energy can be harvested.

Generally, the lumen side of the membrane faces the inlet stream having a higher pressure. In this configuration, the active layer (e.g., the polyamide layer) is supported by the phase-inversion layer (e.g., the polyethersulfone substrate). In the reverse configuration, the active layer may delaminate from the supporting phase-inversion layer.

The PWP of thin-film-composite—polyethersulfone (TFC-PES) hollow-fiber membranes were measured by pumping deionized water into their lumen and shell sides counter currently at the same flow rate of 200 mL/min, while the permeate was collected from the shell side. Briefly, the TFC-PES membranes were firstly pressurized from inside-out and conditioned at 3 MPa for 60 minutes and tested at 2 MPa using deionized water for another 60 minutes. Then, the permeate from the shell side was collected, and the PWP (A) was calculated from Eq. (2), below, where ΔV (L) was the volumetric change of the permeate collected over a period of time, Δt (h), during the test; Δ_{M} (m²) was the effective membrane area; and ΔP (MPa) was the transmembrane pressure difference.

$$\begin{matrix}[ Math . 2 ] & \\ A = \frac{Δ V}{{A}_{M} \times Δ t \times Δ P} & ( 2 )\end{matrix}$$

The salt rejections (Rⱼ) was obtained at 2 MPa by using a 2,000 ppm NaCl solution and deionized water as the lumen-side feed and shell-side solution, respectively; both had the same flowrate of 200 mL/min. The conductivities of the feed and permeate were measured using a conductivity meter (SCHOTT Instruments, Lab 960). Then the conductivities were converted into corresponding salt concentrations. Thus, the salt rejection (Rⱼ) can be calculated by using Eq. (3), below, where C_{F} and C_{P} refer to the concentrations of the feed and permeate, respectively, and Cond._{F} and Cond._{P} stand for the conductivities of the feed and permeate, respectively.

$$\begin{matrix}[ Math . 3 ] & \\ {R}_{j} ( \% ) = \frac{{C}_{F} - {C}_{P}}{{C}_{F}} \times 100 = \frac{Cond {.}_{F} - Cond {.}_{P}}{Cond {.}_{F}} \times 100 & ( 3 )\end{matrix}$$

Similarly, salt permeability B (L/(m² hr), LMH) and water permeability (J_{w}, LMH/MPa) were calculated using Eq. (4) and (5), respectively, where Δπ was the osmotic pressure difference across the membrane.

$$\begin{matrix}[ Math . 4 ] & \\ B = A \times ( Δ P - Δ π ) \times \frac{1 - {R}_{j}}{{R}_{j}} & ( 4 )\end{matrix}$$

$$\begin{matrix}[ Math . 5 ] & \\ {J}_{w} = \frac{Δ V}{{A}_{M} \times Δ t \times Δ P} & ( 5 )\end{matrix}$$

Determination of Thin-Film-Composite—Polyethersulfone Hollow-Fiber Membrane Performance for PRO:

A 1.2 mol/L (M) NaCl solution and DI water were employed as the draw and feed solutions, respectively. The PRO tests were conducted by circulating DI water in the shell side and the draw solution in the lumen side of thin-film-composite—polyethersulfone hollow-fiber membranes counter-currently with the same flow rates of 200 mL/min at 25±0.5° C. The membranes were pre-pressurized by the 1.2 M NaCl solution at 3 MPa for 60 minutes before the tests and tested at 2 MPa while the DI water was maintained at atmospheric pressure. The mass of the feed solution was recorded every minute for 60 minutes using a digital data logging system. The water permeation flux, Jᵥ (LMH), was calculated from the volumetric change of the feed solution (ΔV_{F}), as indicated in Eq. 6, below.

$$\begin{matrix}[ Math . 6 ] & \\ {J}_{v} = \frac{Δ {V}_{F}}{{A}_{M} \times Δ t} & ( 6 )\end{matrix}$$

The reverse salt flux from the draw solution to the feed solution, J_{S} [g/(m² h), gMH], was calculated from the change of salt concentration in the feed solution where C_{F} and V_{F} were the salt concentration and volume of the feed solution, respectively, as indicated in Eq. 7, below.

$$\begin{matrix}[ Math . 7 ] & \\ {J}_{s} = \frac{Δ ( {V}_{F} {C}_{F )}}{{A}_{∖ τ} \times Δ t} & ( 7 )\end{matrix}$$

The structural parameter, S, of the membranes is defined in Eq. (8), where τ, ε_{M} and W are the tortuosity, porosity and wall thickness of the hollow-fiber substrates, respectively.

$$\begin{matrix}[ Math . 8 ] & \\ S = \frac{τ W}{{ε}_{M}} & ( 8 )\end{matrix}$$

However, the substrate tortuosity could not be accurately measured. Thus, the structural parameter, S, was calculated from Jᵥ, A, and B values by solving Eq. 9, where π_{D} is the osmotic pressure of the draw solution and π_{F} is the osmotic pressure of the feed solution, respectively. D is the diffusion coefficient of the NaCl solution and is 1.5×10⁻⁹ m²/s.

$$\begin{matrix}[ Math . 9 ] & \\ {J}_{v} = A ( \frac{{π}_{D} - {π}_{F} exp ( {J}_{v} S / D )}{1 - \frac{B}{{J}_{v}} ( 1 - exp ( {J}_{v} S / D ) )} - Δ P ) & ( 9 )\end{matrix}$$

Determination of Thin-Film-Composite—Polyethersulfone Hollow-Fiber Membrane Performance for Osmotically Assisted Reverse Osmosis:

The osmotically assisted reverse osmosis (OARO) tests were accomplished in a counter-current flow at the same flow rate of 200 mL/min by circulating salty solutions with the same concentration at both the lumen and shell sides of the thin-film-composite—polyethersulfone (TFC-PES) hollow-fiber membranes. In this study, three salty solutions were employed; namely, 0.035 M (2000 ppm), 0.6 M, and 1.2 M NaCl. First, the TFC-PES membranes were pressurized from inside-out and conditioned at 3 MPa for 60 minutes, then the membranes were tested at a hydraulic pressure varying from 1 to 3 MPa at the lumen side, while the shell side was maintained at atmospheric pressure. The permeate collected from the shell side was used to calculate the water permeability from Eq. (5).

Results and Discussion

Polyethersulfone Hollow-Fiber Substrates:

The polyethersulfone (PES) hollow-fiber substrates are firstly fabricated and optimized by tuning their dope and bore fluid flow rates, wall thickness and morphology because they determine the overall mechanical properties of the thin-film-composite—polyethersulfone hollow-fiber membranes. The ultrathin polyamide selective layer has minor or negligible effects on the overall mechanical properties. Table 2 summarizes the physical and mechanical properties of PES hollow-fiber substrates spun from different conditions. As the dope-to-bore-fluid-flow-rate ratio (i.e., D/B ratio) increases from 3 to 13.3, the wall thickness of the hollow fibers increases from approximately 270 to 400 am while the porosity decreases from around 68.4 to 64.5%.

TABLE 2

| | Membrane ID Code | | | | | |
|---|---|---|---|---|---|---|
| | A | B | C | D | E | F |
| D/B Ratio | 3.0 | 5.0 | 7.5 | 10.0 | 10.0 | 13.3 |
| Outer Diameter | 1027.1 ± | 1042.8 ± | 1051.4 ± | 1058.8 ± | 1063.4 ± | 1096.7 ± |
| (μm) | 12.4 | 9.4 | 11.2 | 7.6 | 15.5 | 13.1 |
| Inner Diameter | 480.9 ± | 413.2 ± | 364.7 ± | 325.8 ± | 324.1 ± | 293.1 ± |
| (μm) | 4.4 | 6.1 | 7.8 | 5.8 | 8.9 | 5.5 |
| Wall thickness | 273.1 ± | 314.4 ± | 348.2 ± | 368.6 ± | 369.5 ± | 401.5 ± |
| (μm) | 7.2 | 2.3 | 4.9 | 3.1 | 5.5 | 6.8 |
| Porosity (%) | 68.4 ± | 67.3 ± | 66.6 ± | 66.3 ± | 65.1 ± | 64.5 ± |
| | 0.3 | 0.6 | 0.4 | 0.5 | 0.8 | 0.4 |
| Maximum tensile | 8.5 ± | 8.7 ± | 8.8 ± | 8.9 ± | 8.9 ± | 9.5 ± |
| stress (MPa) | 0.1 | 0.2 | 0.2 | 0.1 | 0.2 | 0.3 |
| Maximum tensile | 78.0 ± | 85.1 ± | 86.1 ± | 88.3 ± | 91.7 ± | 92.8 ± |
| strain (%) | 3.3 | 2.8 | 2.8 | 3.7 | 4.3 | 2.2 |
| Young's modulus | 252.6 ± | 259.3 ± | 263.1 ± | 264.9 ± | 267.2 ± | 273.4 ± |
| (MPa) | 3.3 | 4.3 | 4.5 | 4.8 | 3.7 | 4.7 |
| Burst Pressure | 4.7 ± | 5.9 ± | 6.8 ± | 7.8 ± | 8.5 ± | 9.1 ± |
| (MPa) | 0.2 | 0.4 | 0.2 | 0.3 | 0.3 | 0.4 |

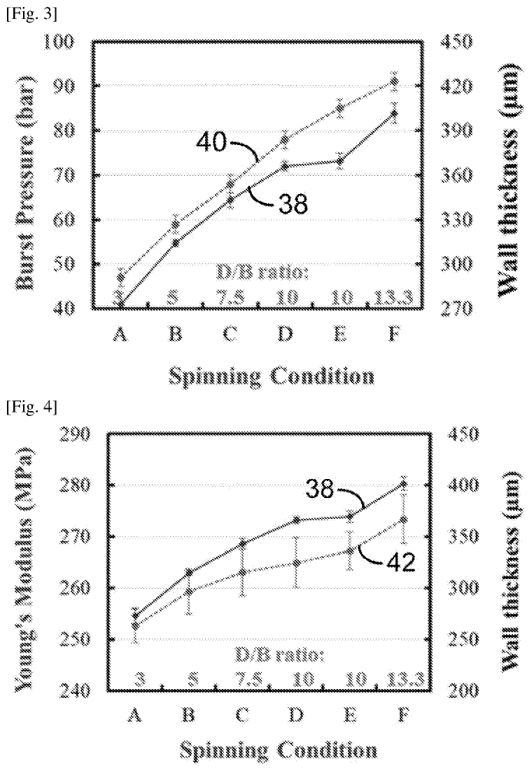

As plotted in FIGS. 3 and 4, an increase in the D/B ratio results in an increase in the wall thickness 38, burst pressure 40, and Young's modulus 42 of the hollow-fiber substrates. The latter two increase from 252 to 273 MPa and from 4.7 to 9.1 MPa, respectively. The burst pressure is the maximum pressure that a hollow-fiber membrane can withstand under the inside-out testing mode. The significant enhancement in burst pressure indicates that the anti-expansion properties of the hollow-fiber substrates can be achieved by increasing their wall thickness and lowering their porosity. Because an increase in the D/B ratio during spinning produces a thicker nascent hollow-fiber wall that takes a longer time for solvent exchange between the solvent (NMP) and nonsolvent (water), this leads to a slower phase inversion and the polymer chains have time to rearrange and pack better. Thus, the resultant substrate may have a less porous structure and porosity.

Interestingly, the hollow-fiber substrates spun from Conditions D and E have close mechanical properties and wall thicknesses when increasing the dope flow rate from 3 to 4 mL/min but keeping the same D/B ratio. This is because the D/B ratio is an important spinning parameter in determining the phase inversion process at both inner and outer surfaces. Nevertheless, even though the substrates spun from Conditions D and E have similar phase inversion at surfaces, the one spun from Condition D has a slightly smaller outer diameter and a slightly larger inner diameter than that from Condition E, as tabulated in Table 2. As a result, they have almost the same maximum tensile strength (8.9±0.1 vs. 8.9±0.2) because (1) they have almost the same phase inversion process at both inner and outer surfaces and (2) the inner and outer skins bear most tensile loads during the tensile tests. However, the substrate spun from Condition D has slightly smaller maximum tensile strain and Young's modulus than that spun from Condition E because the latter has a slightly thicker fiber wall and a slightly lower porosity than the former. Therefore, the latter has a higher burst pressure than the former.

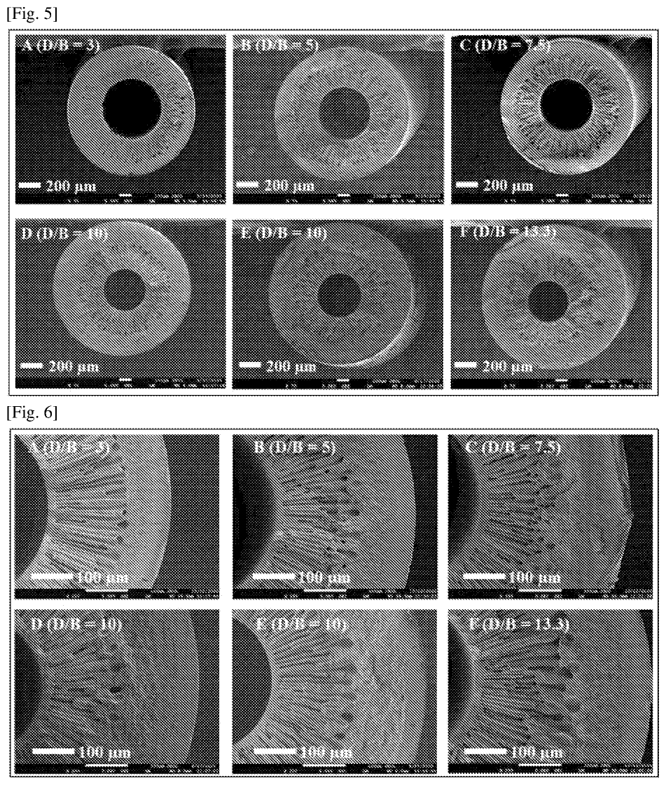

The field-emission-scanning-electron-microscopy (FESEM) morphologies of the hollow-fiber substrates have verified the above hypotheses. [FIG. 5] displays the overall cross-section structure and [FIG. 6] enlarges the detailed cross-section morphology as a function of the D/B ratio (3, 5, 7.5, 10, 10, and 13. 3, respectively for conditions A-F, the parameters of which are set forth in Table 3, below). Generally, all cross-sections comprise an inner layer full of finger-like macrovoids and an outer layer with a sponge-like microstructure. Cross-sectional images that show these structures are provided in [FIG. 18]. The origins of macrovoids in the inner-layer region are most likely from non-solvent intrusion from the bore fluid and the effect of die swelling, while the sponge-like structure formed in the outer-layer region is caused by the delayed de-mixing.

Since the use of a higher D/B ratio during spinning leads to a thicker nascent fiber wall that would induce greater delayed de-mixing, the percentage of the finger-like area decreases while that of the sponge-like area increases with an increase in D/B ratio. Among the illustrated embodiments, the percentage of the finger-like area in the overall fiber-wall thickness was highest (66%) in condition A, shown at upper left in [FIG. 18], where the D/B ratio was 3.0. Second, the percentage of the finger-like area was 63% in condition B, shown at top center in [FIG. 18], where the D/B ratio was 5.0. Third, the percentage of the finger-like area was 59% in condition C, shown at top right in [FIG. 18], where the D/B ratio was 7.5. Fourth, the percentage of the finger-like area was 56% in both condition D and condition E, shown at bottom left and bottom center, respectively, in [FIG. 18], where the D/B ratio was 10.0 for both conditions. Finally, the percentage of the finger-like area was 57% in condition F, shown at bottom right in [FIG. 18], where the D/B ratio was 13.3.

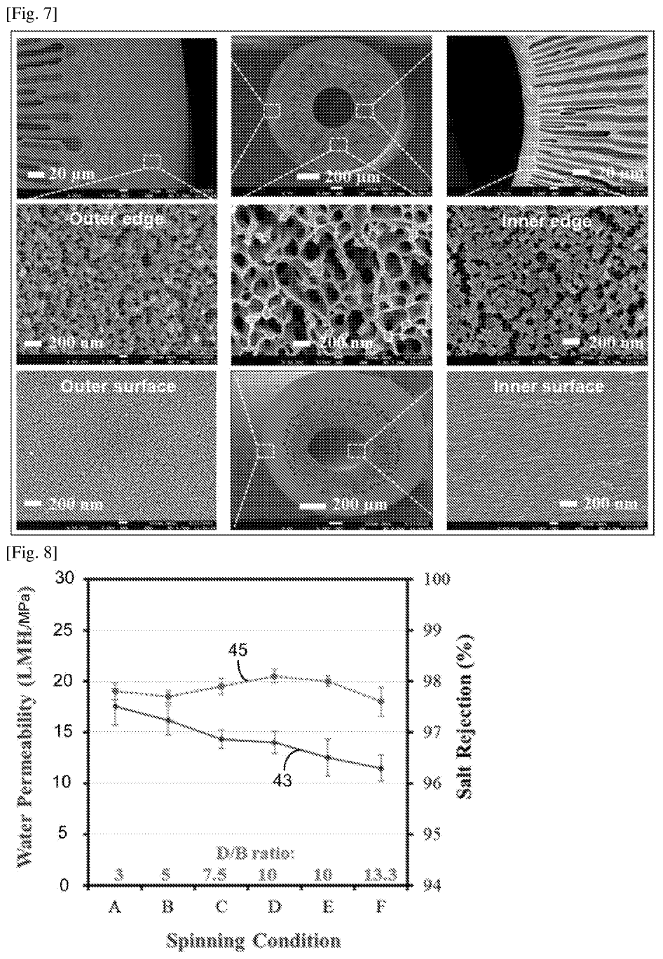

In terms of mechanical properties, finger-like macrovoids are the weak points of hollow fibers. Therefore, the decrease in the area percentage of finger-like macrovoids leads to a stronger hollow-fiber substrate with an increase in D/B ratio. Consistent with our previous discussion, [FIG. 7] shows typical inner (right-most images) and outer (left-most images) surface morphologies of the polyethersulfone hollow-fiber substrate. They have thin and relatively dense skin layers because water has been employed as the inner and external coagulants. Since water is a powerful nonsolvent, it induces fast coagulations at both surfaces (referred to as instantaneous de-mixing) and relatively dense skin morphology.

Transport Properties and Reverse-Osmosis Performance of Thin-Film-Composite—Polyethersulfone Hollow-Fiber Membranes:

The thin-film-composite—polyethersulfone (TFC-PES) hollow-fiber membranes were evaluated for brackish water desalination using a NaCl solution of 2000 ppm as the feed at 2 MPa. Table 3, below summarizes their separation performance in terms of pure-water permeability (A), salt rejection (Rⱼ), salt permeability (B), and water permeability (J_{w}). The pure-water permeability (PWP) value decreases with an increase in the D/B ratio from 31 to 26 LMH/MPa because of the lower porosity and a thicker fiber wall with an increase in the D/B ratio.

TABLE 3

| | | | Water | | | |
|---|---|---|---|---|---|---|
| | | | Perme- | | Salt | |
| | | PWP | ability | Salt | Perme- | Burst |
| | | (A) | (JW) | Rejection | ability | Pressure |
| Membrane | D/B | (LMH/ | (LMH/ | (R) | (B) | (P_{B}) |
| Condition | Ratio | MPa) | MPa) | (%) | (LMH) | (MPa) |
| A | 3.0 | 30.8 ± | 17.5 ± | 97.8 ± | 1.27 ± | 5.5 |
| | | 2.5 | 1.8 | 0.16 | 0.06 | |
| B | 5.0 | 30.5 ± | 16.2 ± | 97.7 ± | 1.31 ± | 7.1 |
| | | 1.8 | 1.5 | 0.11 | 0.04 | |
| C | 7.5 | 29.8 ± | 14.3 ± | 97.9 ± | 1.17 ± | 8.0 |
| | | 3.8 | 0.9 | 0.15 | 0.03 | |
| D | 10.0 | 28.1 ± | 14.0 ± | 98.1 ± | 1.01 ± | 8.4 |
| | | 1.5 | 1.1 | 0.13 | 0.08 | |
| E | 10.0 | 27.7 ± | 12.5 ± | 98.0 ± | 1.03 ± | 9.5 |
| | | 3.1 | 1.8 | 0.11 | 0.05 | |
| F | 13.3 | 26.1 ± | 11.5 ± | 97.6 ± | 1.27 ± | 10.4 |
| | | 3.7 | 1.3 | 0.28 | 0.04 | |

All of the membranes were conditioned at 3 MPa for 60 minutes and then tested at 2 MPa at 25° C.

[FIG. 8] shows the water permeability 43 and NaCl rejection 45 of TFC-PES hollow-fiber membranes as a function of the D/B ratio. The water permeability decreases remarkably from 17.5 to 11.5 LMH/MPa with an increase in the D/B ratio. This decreasing trend is consistent with the PWP results but is more severe for brackish water desalination possibly due to concentration polarization. The formation of a thicker hollow fiber with a lower porosity from a higher D/B ratio may not only increase the transport resistance but also enhance the concentration polarization across the membrane that decrease the overall water permeability. However, the NaCl rejection remains almost constant, it varies from 97.6 to 98.1%. This is because all TFC-PES hollow-fiber membranes spun from various D/B ratios have the same polyamide as the selective layer.

[FIG. 9] shows that the apparent thickness of the polyamide selective layer varies from about 250 to 400 nm for thin-film-composite—polyethersulfone (TFC-PES) hollow-fiber membranes spun from the different D/B ratios for conditions A-F, reported in Tables 2 and 3, above. All polyamide surfaces have the typical ridge-and-valley morphology because it is a characteristic of the polyamide layer synthesized by interfacial polymerization. [FIG. 9] also reveals that the TFC-PES hollow-fiber membranes spun from a higher D/B ratio have a thinner polyamide layer. This declining trend might be attributed to the combined effects of two factors. First of all, due to the capillary pressure induced by the pores near the inner surface region and finger-like macrovoids, the M-phenylenediamine (MPD) solution would be pulled into the bulk membrane and absorbed in pores for the subsequent interfacial polymerization. Since a higher D/B ratio would produce hollow-fiber substrates with a thicker wall, this would significantly slow down the back diffusion of MPD molecules to the lumen for reaction with trimesoyl chloride (TMC). This phenomenon leads to form a thinner thin-film-composite layer with an increase in D/B ratio.

Besides, the use of a fixed TMC flow rate during the interfacial polymerization (IP) process (to form the active polyamide layer) leads to a higher TMC flow velocity through the lumen of the hollow-fiber substrate if it has a smaller inner diameter. In the IP process, an MPD solution is introduced to the lumen side of the PES support layer and then flushed out by blowing air through the lumen side, so only a residual film remains; a TMC solution is then flowed through the lumen side, where it interacts with the MPD film and polymerizes into polyamide, forming the support layer. As shown in [FIG. 5], a higher D/B ratio results in the hollow-fiber substrate having a smaller lumen diameter. This leads to a faster TMC flow velocity and a shorter reaction time that not only confine the interfacial polymerization but also the growth of the polyamide layer on top of the inner surface. Besides, a higher TMC flow velocity through the lumen may lead to form a polyamide layer not only on top of the inner surface but also within the pores near the inner-surface region. Thus, an apparently thinner polyamide layer is formed.

Table 3, above, shows the burst pressure of TFC-PES hollow-fiber membranes as a function of D/B ratio. Comparing with PES hollow-fiber substrates, the TFC-PES hollow-fiber membranes have a similar relationship between their burst pressures and D/B ratios because the former plays a major role in determining the overall mechanical properties of the latter. Interestingly, a comparison of their burst pressures (as tabulated in Tables 2 and 3) indicates that TFC-PES hollow-fiber membranes have about 10 to 20% higher burst pressures than their corresponding substrates. The improvement may result from the enhanced mechanical properties of the inner-layer region due to the interfacial polymerization. In other words, the capillary pressure and the high TMC flow velocity through the lumen of the hollow-fiber substrate may induce the interfacial polymerization reaction not only on the inner-layer surface but also within the pores near the inner-surface region. Thus, the mechanical properties of the TFC-PES hollow-fiber membranes are improved. On the other hand, the formation of a polyamide layer deeper inside the inner-surface pores increases the water transport length. This would lead to lower pure-water permeability (PWP) and water permeability for the TFC-PES hollow-fiber membranes prepared from substrates with higher D/B ratios.

Concentration Polarization and Structural Parameter of Thin-Film-Composite—Polyethersulfone Hollow-Fiber Membranes:

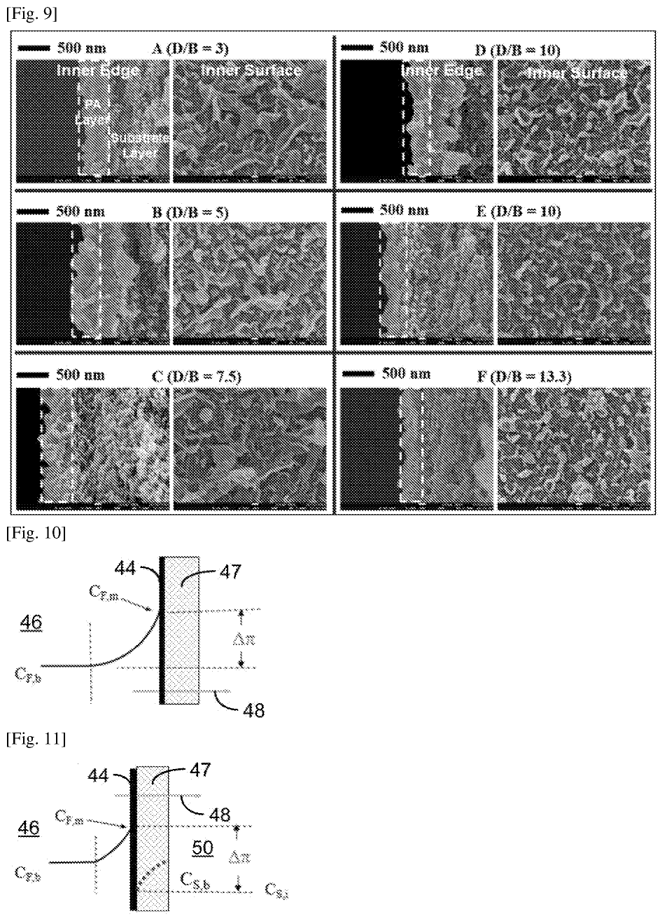

Concentration polarization (referred to as CP) plays an important role in determining membrane performance under osmosis processes because water permeability is strongly affected by the osmotic pressure difference (Δπ) across the membranes. However, CP behaves quite differently in RO, forward osmosis (FO), pressure retarded osmosis (PRO) and osmotically assisted reverse osmosis (OARO). As illustrated in [FIG. 10], RO is a pressure driven process. A high hydraulic pressure (P) is employed to overcome Δπ so that water transports 48 from the feed 46 across the polyamide selective layer 44 (serving as the active layer) on the hollow-fiber substrate 47. This results in a serious concentrative external CP (referred to as ECP) facing the polyamide layer 44. The ECP induces a greater Δσ and thus reduces the effective driving force (P−Δπ) for water transport 48.

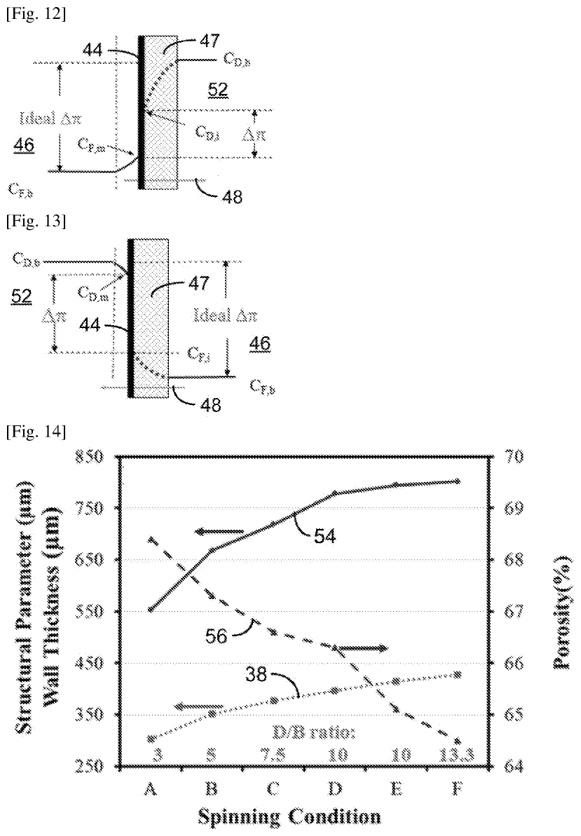

In contrast, under no external hydraulic pressure, FO ([FIG. 12]) and PRO ([FIG. 13]) tend to have lower ECP, but a more-serious inner concentration polarization (ICP). Because they are osmotic driven processes, Δπ is the only driving force for mass transport across the membrane. However, Δπ is significantly affected by (1) the orientation of the membrane configuration, (2) the concentration profile of the draw solute 52 in the hollow-fiber substrate 47 under FO ([FIG. 12]) or (3) the concentration profile of the feed 46 in the substrate under PRO ([FIG. 13]). Generally, FO has a greater dilutive ICP than PRO because the concentrated draw solution 52 is significantly diluted in the hollow-fiber substrate 47 due to the water inflow 48 (as illustrated in [FIG. 12]); thus, the former has a lower au and a smaller flux than the latter. Similar to RO, OARO ([FIG. 11]) employs a high hydraulic pressure, thus it has a severe concentrative ECP (C_{F,m}) facing the selective/active layer 44. However, it also has a serious ICP inside the membrane because the permeate water dilutes the salt concentration of the sweep 50 in the hollow-fiber substrate 47 (as illustrated in [FIG. 13]). These ECP and ICP lead to additional a, which needs to be overcome by the hydraulic pressure. Therefore, it is advantageous optimize the substrate characteristics in order to diminish the severity of ICP.

Basically, an advantageous substrate for FO and PRO membranes is thin and has an open and interconnected pore structure to lower the ICP. These characteristics may be mathematically elucidated by the structural parameter (S), as defined in Eq. 8. A substrate with a smaller S tends to form a TFC membrane with a lower ICP. For this purpose, we investigate membrane performance under the PRO mode at 2 MPa and calculate the membranes' structural parameters and tortuosity (Eqs. 8 and 9). Table 4, below, summarizes the PRO results as a function of the D/B ratio. The S parameter increases with an increase in the D/B ratio and reaches a maximum value of 802 μm at the D/B ratio of 13.3 (Condition F), while the tortuosity varies in a narrow range of 1.21-1.29. [FIG. 14] plots the relationship among the S parameter 54, wall thickness 38, and porosity 56 as a function of the D/B ratio. Clearly, the membrane spun from a higher D/B ratio has a larger S parameter 54 due to a thicker substrate wall with a smaller porosity, as written in Eq. 8.

TABLE 4

| | | Water | Reverse | Structural | |
|---|---|---|---|---|---|
| | | Flux | Salt Flux | Parameter | |
| Membrane | D/B | (Jᵥ) | (J_{S}) | (S) | Tortuosity |
| ID Code | Ratio | (LMH) | (gMH) | (%) | (τ) |
| A | 3.0 | 29.51 ± 0.51 | 23.41 ± 0.48 | 553 | 1.24 |
| B | 5.0 | 23.63 ± 0.39 | 22.68 ± 0.37 | 668 | 1.27 |
| C | 7.5 | 22.71 ± 0.63 | 20.82 ± 0.51 | 719 | 1.27 |
| D | 10.0 | 21.64 ± 0.35 | 17.55 ± 0.31 | 778 | 1.29 |
| E | 10.0 | 20.81 ± 0.54 | 17.31 ± 0.46 | 795 | 1.25 |
| F | 13.3 | 19.92 ± 0.49 | 18.14 ± 0.43 | 802 | 1.21 |

All of the membranes were conditioned at 3 MPa (60 min) and then tested at 2 MPa at 25° C.

Osmotically Assisted Reverse Osmosis Performance of Thin-Film-Composite—Polyethersulfone Hollow-Fiber Membranes:

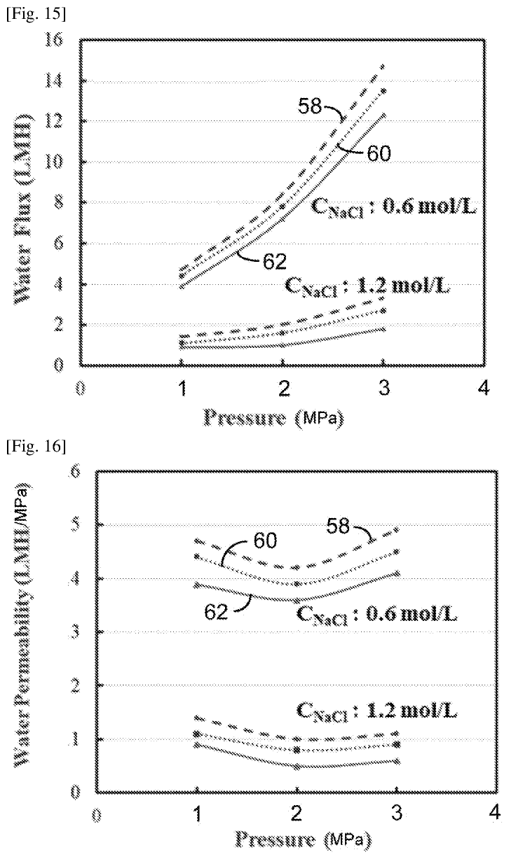

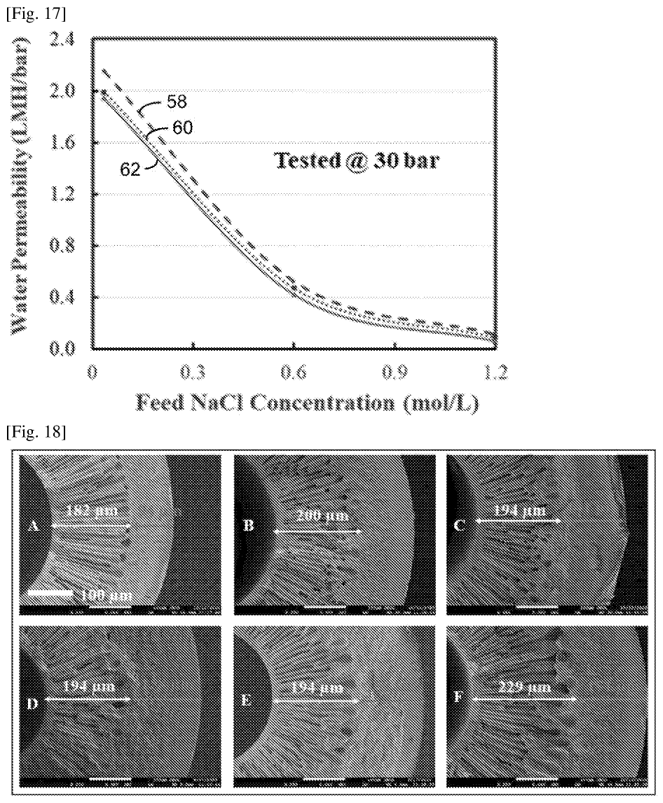

Since the membranes spun from conditions D, E and F have higher mechanical strengths, burst pressures and good RO performance in terms of water permeability and salt rejection, they were selected for osmotically assisted reverse osmosis (OARO) tests. All membranes were conditioned and stabilized at 3 MPa for at least 60 minutes prior to the tests. [FIG. 15] shows the OARO performance for condition D 58, condition E 60, and condition F 62 in terms of water flux as a function of operating pressure, while [FIG. 16] shows their OARO performance in terms of water permeability as a function of operating pressure. Two salt concentrations are employed; namely, 0.6 M and 1.2 NaCl. If the feed and sweep have 0.6 M NaCl, the water stream flux increases from the lowest value of 3.9 LMH at 1 MPa for the membrane spun from condition F 62 to the highest one of 14.7 LMH at 3 MPa for the membrane spun from condition D 58. If a 1.2 M NaCl solution is employed as the feed and sweep streams, the water flux increases from the lowest value of 0.9 LMH at 1 MPa for the membrane spun from condition F 62 to the highest one of 3.3 LMH at 3 MPa for the membrane spun from condition D 58.

Basically, the flux increment is mainly due to the increase in the driving force (P−Δπ) when increasing the operating pressure. The orders of water flux and water permeability in these membranes follow the order of spinning conditions, D 58>E 60>F 62, because the severity of their inner concentration polarization (ICP) obeys a reverse trend as F 62>E 60>D 58 (i.e., the order of S parameters in Table 4). In other words, the thin-film-composite—polyethersulfone hollow-fiber membrane with a lower S parameter suffers from a less diluting ICP effect and, thus, has a higher water flux and water permeability. Among these three membranes, the membrane fabricated under condition E 60 has the most balanced performance for OARO because it has a high burst pressure of 9.5 MPa and a reasonable water permeability of 0.9 LMH/MPa using 1.2 M NaCl as the feed. Interestingly, the water permeability shows a down and up trend as illustrated in [FIG. 16] for both 0.6 and 1.2 M concentrations. This V trend arises from the combined effects of ICP and membrane expansion at high pressures. On one hand, a high operating pressure increases the water flux that causes a severe diluting ICP in the substrate, this leads to a smaller driving force (P−Δπ) across the membrane and a smaller water permeability. On the other hand, the hollow-fiber membrane expands circumferentially when a high pressure of >2 MPa is applied in its lumen side. This results in a thinner substrate wall, a more-porous substrate, and a smaller S parameter that leads to a higher water permeability. Therefore, the water permeability reverses the decreasing trend induced by ICP at a high pressure of 3 MPa.

[FIG. 17] shows the water permeability decreasing dramatically as the NaCl concentration increases from 0.035 M (2000 ppm) to 1.2 M. For example, the water permeability of the membrane spun from condition D 58 declines from 21.5 to 1.1 LMH/MPa while those from conditions E 60 and F 62 decrease from 19.9 to 0.9 LMH/MPa and from 19.4 to 0.6 LMH/MPa, respectively. Similar to the previous discussion, the decline in water permeability is caused by the inner concentration polarization (ICP) in the substrate as well as the external concentration polarization (ECP) due to the increase of osmotic pressure in the feed solution from 167 kPa (0.035 M, NaCl) to 587 kPa (1.2 M, NaCl).

Table 5, below, benchmarks the applications of thin-film-composite (TFC) membranes for reverse-osmosis/pressure-retarded-osmosis (RO/PRO) processes, wherein the last three (i.e., TFC-PES-Conditions D-F) are from this work. Compared to the literature, the newly developed membranes have higher salt rejections and much higher burst pressures. They have comparable water permeability with others but a slightly larger S parameter than others. Since we have comparable water permeability, superior salt rejections and much higher burst pressures, these balanced performances imply that the ICP effect in our membranes is not a major problem. The newly developed membranes may have great potential for high pressure RO, PRO, and OARO applications.

TABLE 5

| | | | | | Struc- | |
|---|---|---|---|---|---|---|
| | Dope | | | | tural | |
| | Solution | | PWP | Salt | Param- | Burst |
| | Polymer | Membrane | (A) | Rej. | eter | Pressure |
| | Conc. | Config- | (LMH/ | (Rⱼ) | (S) | (P_{B}) |
| Membrane | (wt. %) | uration | MPa) | (%) | (μm) | (MPa) |
| TFC-P84 | 21 | Hollow Fiber | 9.1 | 97.8 | 685 | 2.4 |
| TFC-PES | 20 | Hollow Fiber | 33.0 | 97.6 | 450 | 2.1 |
| TFC-PES | 20 | Hollow Fiber | 38.0 | 97.3 | 430 | 3.3 |
| TFC-PES | 20 | Hollow Fiber | 30.7 | 96.5 | 475 | 2.2 |
| TFC-PES | 21 | Hollow Fiber | 12.7 | 97.7 | 522 | 1.9 |
| with GO | | | | | | |
| PAI-PAH | 22 | Hollow Fiber | 11.0 | 69.0 | 437 | 2.2 |
| Crosslinking | | | | | | |
| TFC with | 16 | Flat Sheet | 26.0 | 96.1 | 474 | 2.7 |
| CNT-PEI | | | | | | |
| TFC-PES | | Hollow Fiber | 33.2 | ---- | 460 | 0.9 |
| TFC-MATR | 18 | Hollow Fiber | 19.0 | 87.8 | 776 | 1.6 |
| IMID | | | | | | |
| 5218 | | | | | | |
| TFC-HTI | | Flat Sheet | 24.9 | | 564 | 4.8 |
| (Commercial | | | | | | |
| Substrate) | | | | | | |
| TFC-PES- | 26 | Hollow Fiber | 28.1 | 98.1 | 778 | 8.4 |
| Condition D | | | | | | |
| TFC-PES- | 26 | Hollow Fiber | 27.7 | 98.0 | 795 | 9.5 |
| Condition E | | | | | | |
| TFC-PES- | 26 | Hollow Fiber | 26.1 | 97.6 | 802 | 10.4 |
| Condition F | | | | | | |

We have developed high-mechanical-strength thin-film-composite—polyethersulfone (TFC-PES) hollow-fiber membranes for reverse-osmosis (RO) and osmotically-assisted-reverse-osmosis OARO applications. The newly developed membranes comprise a polyethersulfone (PES) substrate coated with an ultrathin M-phenylenediamine/trimesoyl-chloride (MPD/TMC) polyamide as the selective layer. The following conclusions can be drawn.

First, the dope-to-bore-fluid flowrate (D/B) ratio plays an important role in determining the mechanical strength, structural parameter, pure-water permeability (PWP) and water permeability of TFC-PES hollow-fiber membranes for RO and OARO applications. The structural parameter increases from 553 μm to 802 μm when the D/B ratio is increased from 3 to 13.3.

Second, for brackish-water desalination, the newly developed hollow-fiber membranes have a pure-water permeability (PWP) of around 25 to 30 L/(m² h MPa) (LMH/MPa) and a NaCl rejection of around 97.5 to 98% at 2.0 MPa.

Third, under the OARO mode, both water flux and water permeability of the membranes decrease significantly as the salt concentrations of the feed and sweep streams increase from 0.035 M (2000 ppm) to 1.2 M. The water flux drops from about 57 to 1.7 LMH, and their corresponding water permeability declines from about 19 to 0.6 LMH/MPa due to the combined effects of external concentration polarization (ECP) and inner concentration polarization (ICP) that reduces the overall effective driving force across the membranes.

Fourth, according to the burst pressure, the structural parameter, and the water permeability under the OARO mode, the TFC-PES hollow-fiber membrane fabricated under condition E has the most balanced performance. It has a burst pressure of 9.5 MPa, a structural parameter of 795 μm and a water permeability of 0.9 LMH/MPa using a 1.2 M NaCl solution as the feed.

Additional examples consistent with the present teachings are set out in the following numbered clauses:
1. A thin-film-composite hollow-fiber membrane comprising: a phase-inversion layer in the form of a hollow fiber substrate; and an active layer coated on the phase-inversion layer, wherein the active layer selectively allows passage of water molecules but rejects at least some dissolved ions, wherein the thin-film-composite hollow-fiber membrane has an internal burst pressure of at least 4 MPa.
2. The thin-film-composite hollow-fiber membrane of clause 1, wherein the phase-inversion layer is an outer layer and the active layer is an inner layer.
3. The thin-film-composite hollow-fiber membrane of any one of the previous clauses, wherein the phase-inversion layer is formed of polyethersulfone and/or polysulfone.
4. The thin-film-composite hollow-fiber membrane of any one of the previous clauses, wherein the active layer is formed via an interfacial polymerization process.
5. The thin-film-composite hollow-fiber membrane of any one of the previous clauses, wherein the phase-inversion layer comprises a finger-like macrovoid region and a sponge-like region.
6. The thin-film-composite hollow-fiber membrane of clause 5, wherein the phase-inversion layer has a wall thickness, the finger-like macrovoid region has a thickness, and the thickness of the finger-like macrovoid region is no greater than 70% of the wall thickness.
7. The thin-film-composite hollow-fiber membrane of any one of the previous clauses, wherein the internal burst pressure is at least 7 MPa.
8. The thin-film-composite hollow-fiber membrane of any one of the previous clauses, wherein the internal burst pressure is at least 10 MPa.
9. The thin-film-composite hollow-fiber membrane of any one of the previous clauses, wherein the active layer has a thickness that is between 100 and 600 nm.
10. The thin-film-composite hollow-fiber membrane of any one of the previous clauses, wherein the hollow-fiber membrane has an outer diameter between 800 and 1200 um.
11. The thin-film-composite hollow-fiber membrane of any one of the previous clauses, wherein the hollow-fiber membrane has an inner diameter between 150 and 500 um.
12. The thin-film-composite hollow-fiber membrane of any one of the previous clauses, wherein the hollow-fiber membrane has a wall thickness of at least 250 um.
13. The thin-film-composite hollow-fiber membrane of any one of the previous clauses, wherein the hollow-fiber membrane has a wall thickness of at least 350 um.
14. The thin-film-composite hollow-fiber membrane of any one of the previous clauses, wherein the hollow-fiber membrane has a porosity between 55% and 80%.
15. The thin-film-composite hollow-fiber membrane of any one of the previous clauses, wherein the hollow-fiber membrane has a maximum tensile stress of at least 5.5 MPa.
16. The thin-film-composite hollow-fiber membrane of any one of the previous clauses, wherein the hollow-fiber membrane has a Young's Modulus of at least 170 MPa.
17. The thin-film-composite hollow-fiber membrane of any one of the previous clauses, wherein the hollow-fiber membrane has a structural parameter below 0.9 mm.
18. The thin-film-composite hollow-fiber membrane of any one of the previous clauses, wherein the hollow-fiber membrane has a pure water permeability of at least 25 LMH/MPa.
19. The thin-film-composite hollow-fiber membrane of any one of the previous clauses, wherein the hollow-fiber membrane has a NaCl rejection rate of at least 90%.
20. The thin-film-composite hollow-fiber membrane of any one of the previous clauses, wherein the hollow-fiber membrane has a NaCl rejection rate of at least 97%.
21. A method for synthesizing a thin-film-composite hollow-fiber membrane, comprising:
forming a spinning dope comprising a polymer, a polar solvent, a pore-forming additive, a nonsolvent, and a mineral additive;
providing a spinneret that has an external orifice and an internal orifice;
extruding the spinning dope through the external orifice through an air gap into a coagulation bath containing a coagulant and simultaneously flowing a bore fluid through the internal orifice to form a hollow-fiber substrate;
post-treating the hollow-fiber substrate by immersion in a glycerol solution; and
forming an active layer on a surface of the hollow-fiber substrate, wherein
the thin-film-composite hollow-fiber membrane has a burst pressure of at least 4 MPa.
22. The method of clause 21, wherein the active layer is formed on an inner surface of the hollow-fiber substrate.
23. The method of any one of clauses 21-22, wherein the polymer concentration in the spinning dope is no greater than 5% below a critical concentration at which extensive polymer chain entanglement occurs.
24. The method of any one of clauses 21-23, wherein the polymer concentration is at least 20%.
25. The method of any one of clauses 21-24, wherein the spinning dope is extruded at a dope rate, the bore fluid is flowed at a bore rate, and the ratio of the dope rate to the bore rate is at least 2.
26. The method of any one of clauses 21-25, wherein the spinning dope is extruded at a dope rate, the bore fluid is flowed at a bore rate, and the ratio of the dope rate to the bore rate is at least 10.
27. The method of any one of clauses 21-26, wherein the polymer includes at least one of polyethersulfone and polysulfone.
28. The method of any one of clauses 21-27, wherein the polar solvent comprises N-methyl-2-pyrrodlidone, dimethylformamide, and/or dimethyl sulfoxide.
29. The method of any one of clauses 21-28, wherein the pore-forming additive is polyethylene glycol having a molecular weight of about 400 g/mol.
30. The method of any one of clauses 21-29, wherein the nonsolvent is deionized water.
31. The method of any one of clauses 21-30, wherein the mineral additive is calcium chloride.
32. The method of any one of clauses 21-31, wherein the coagulant is water.
33. The method of any one of clauses 21-32, wherein the concentration of glycerol solution contains 50% glycerol by weight and 50% water by weight.
34. The method of any one of clauses 21-33, wherein forming an active layer comprises flowing a first solution comprising M-phenylenediamine and sodium dodecyl sulphate across a surface of the hollow-fiber substrate, and flowing a second solution comprising trimesoyl chloride and hexane across the surface of the hollow-fiber substrate.
35. The method of clause 34, wherein the concentration of M-phenylenediamine in the first solution is about 2%.
36. The method of any one of clauses 34-35, wherein the concentration of sodium dodecyl sulphate in the first solution is about 0.1%.
37. The method of any one of clauses 34-36, wherein the concentration of trimesoyl chloride is about 0.15%.
38. The method of any one of clauses 21-37, wherein the spinning dope is extruded at a rate of 2 to 4 ml/min.
39. The method of any one of clauses 21-38, wherein the bore fluid is flowed at a rate of 0.3 to 1 ml/min.
40. The method of any one of clauses 21-39, wherein the bore fluid comprises water.
41. The method of any one of clauses 21-40, wherein the coagulant bath has a temperature of about 25° C.
42. The method of any one of clauses 21-41, further comprising potting two or more thin-film-composite hollow-fiber membranes to form a membrane module.
43. A method for synthesizing a thin-film-composite hollow-fiber membrane, comprising:
forming a spinning dope comprising a polymer, a polar solvent, a pore-forming additive, a nonsolvent, and a mineral additive;
providing a spinneret that has an external orifice and an internal orifice;
extruding the spinning dope through the external orifice through an air gap into a coagulation bath containing a coagulant and simultaneously flowing a bore fluid through the internal orifice to form a hollow-fiber substrate;
post-treating the hollow-fiber substrate by immersion in a glycerol solution; and
forming an active layer on an inner or outer surface of the hollow-fiber substrate, wherein
the polymer concentration in the spinning dope is no greater than 5% below a critical concentration at which extensive polymer chain entanglement occurs.
44. The method of clause 43, wherein the active layer is formed on an inner surface of the hollow-fiber substrate.
45. The method of any one of clauses 43-44, wherein the polymer concentration is at least 20%.
46. The method of any one of clauses 43-45, wherein the spinning dope is extruded at a dope rate, the bore fluid is flowed at a bore rate, and the ratio of the dope rate to the bore rate is at least 2.
47. The method of any one of clauses 43-46, wherein the spinning dope is extruded at a dope rate, the bore fluid is flowed at a bore rate, and the ratio of the dope rate to the bore rate is at least 10.
48. The method of any one of clauses 43-47, wherein the polymer includes at least one of polyethersulfone and polysulfone.
49. The method of any one of clauses 43-48, wherein the polar solvent comprises N-methyl-2-pyrrodlidone, dimethylformamide, and/or dimethyl sulfoxide.
50. The method of any one of clauses 43-49, wherein the pore-forming additive is polyethylene glycol having a molecular weight of about 400 g/mol.
51. The method of any one of clauses 43-50, wherein the nonsolvent is deionized water.
52. The method of any one of clauses 43-51, wherein the mineral additive is calcium chloride.
53. The method of any one of clauses 43-52, wherein the coagulant is water.
54. The method of any one of clauses 43-53, wherein the concentration of glycerol solution contains 50% glycerol by weight and 50% water by weight.
55. The method of any one of clauses 43-54, wherein forming an active layer comprises flowing a first solution comprising M-phenylenediamine and sodium dodecyl sulphate across a surface of the hollow-fiber substrate, and flowing a second solution comprising trimesoyl chloride and hexane across the surface of the hollow-fiber substrate.
56. The method of clause 55, wherein the concentration of M-phenylenediamine in the first solution is about 2%.
57. The method of any one of clauses 55-56, wherein the concentration of sodium dodecyl sulphate in the first solution is about 0.1%.
58. The method of any one of clauses 55-57, wherein the concentration of trimesoyl chloride is about 0.15%.
59. The method of any one of clauses 55-58, wherein the spinning dope is extruded at a rate of 2 to 4 ml/min.
60. The method of any one of clauses 43-59, wherein the bore fluid is flowed at a rate of 0.3 to 1 ml/min.
61. The method of any one of clauses 43-60, wherein the bore fluid comprises water.
62. The method of any one of clauses 43-61, wherein the coagulant bath has a temperature of about 25° C.
63. The method of any one of clauses 43-62, further comprising potting two or more thin-film-composite hollow-fiber membranes to form a membrane module.

In describing embodiments, herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

This invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

1. A thin-film-composite hollow-fiber membrane comprising:
a phase-inversion layer in the form of a hollow fiber substrate; and
an active layer coated on the phase-inversion layer, wherein the active layer selectively allows passage of water molecules but rejects at least some dissolved ions,
wherein the thin-film-composite hollow-fiber membrane has an internal burst pressure of at least 4 MPa.

2. The thin-film-composite hollow-fiber membrane of claim 1, wherein the phase-inversion layer is an outer layer and the active layer is an inner layer.

3. The thin-film-composite hollow-fiber membrane of claim 1, wherein the phase-inversion layer is formed of at least one of polyethersulfone and polysulfone.

4. The thin-film-composite hollow-fiber membrane of claim 1, wherein the active layer is formed via an interfacial polymerization process.

5. The thin-film-composite hollow-fiber membrane of claim 1, wherein the phase-inversion layer comprises a finger-like macrovoid region and a sponge-like region.

6. The thin-film-composite hollow-fiber membrane of claim 5, wherein the phase-inversion layer has a wall thickness, the finger-like macrovoid region has a thickness, and the thickness of the finger-like macrovoid region is no greater than 70% of the wall thickness.

7. The thin-film-composite hollow-fiber membrane of claim 1, wherein the internal burst pressure is at least 7 MPa.

8. The thin-film-composite hollow-fiber membrane of claim 1, wherein the internal burst pressure is at least 10 MPa.

9. The thin-film-composite hollow-fiber membrane of claim 1, wherein the active layer has a thickness that is between 100 and 600 nm.

10. The thin-film-composite hollow-fiber membrane of claim 1, wherein the hollow-fiber membrane has an outer diameter between 800 and 1200 um.

11. The thin-film-composite hollow-fiber membrane of claim 1, wherein the hollow-fiber membrane has an inner diameter between 150 and 500 um.

12. The thin-film-composite hollow-fiber membrane of claim 1, wherein the hollow-fiber membrane has a wall thickness of at least 250 um.

13. The thin-film-composite hollow-fiber membrane of claim 1, wherein the hollow-fiber membrane has a wall thickness of at least 350 um.

14. The thin-film-composite hollow-fiber membrane of claim 1, wherein the hollow-fiber membrane has a porosity between 55% and 80%.

15. The thin-film-composite hollow-fiber membrane of claim 1, wherein the hollow-fiber membrane has a maximum tensile stress of at least 5.5 MPa.

16. The thin-film-composite hollow-fiber membrane of claim 1, wherein the hollow-fiber membrane has a Young's Modulus of at least 170 MPa.

17. The thin-film-composite hollow-fiber membrane of claim 1, wherein the hollow-fiber membrane has a structural parameter below 0.9 mm.

18. The thin-film-composite hollow-fiber membrane of claim 1, wherein the hollow-fiber membrane has a pure water permeability of at least 25 LMH/MPa.

19. The thin-film-composite hollow-fiber membrane of claim 1, wherein the hollow-fiber membrane has a NaCl rejection rate of at least 90%.

20. The thin-film-composite hollow-fiber membrane of claim 1, wherein the hollow-fiber membrane has a NaCl rejection rate of at least 97%.

21-63. (canceled)
